(19) United States
(12) Patent Application Publication
(10) Pub. No.: US 2015/0227495 A1
(43) Pub. Date: Aug. 13, 2015

(54) METHOD AND SOFTWARE PROGRAM PRODUCT FOR ORGANIZING BOOKMARKS IN PDF AND OTHER DOCUMENTS

(71) Applicant: Kambiz Hannani, Los Angeles, CA (US)

(72) Inventor: Kambiz Hannani, Los Angeles, CA (US)

(21) Appl. No.: 14/614,329

(22) Filed: Feb. 4, 2015

Related U.S. Application Data
(60) Provisional application No. 61/937,815, filed on Feb. 10, 2014.

(51) Int. Cl. G06F 17/22

(52) U.S. Cl. CPC G06F 17/2235

(57) ABSTRACT

A method for creating and organizing bookmarks in documents, such as PDF documents. Each bookmark includes multiple data fields and is associated with a location of the document. The data values of multiple data fields are inputted by the user when creating the bookmarks. The bookmarks are displayed in a bookmark pane adjacent to the document content display. The bookmarks can be color coded based on data values of data fields specified by the user. The bookmarks can be sorted based on data values of data field(s) specified by the user. In one example, the document is a multipage PDF document.

### BACKGROUND OF THE INVENTION

1. Field of the Invention

This invention relates to a method and related software program product for organizing bookmarks in documents, in particular image-based documents, such as PDF, tiff, etc.

2. Description of the Related Art

In many practical fields, such as medicine, document handling is rapidly moving from paper (hard copy) based systems to electronic document management systems. For example, patient records are now stored as PDF or other image files rather than hard copy form. For documents that contain multiple pages and multiple parts, such as a patient's medical record, it is desirable to provide tools for the user to easily organize various contents of the large document.

### SUMMARY OF THE INVENTION

The present invention is directed to a method and related apparatus for creating and organizing multi-field bookmarks in PDF documents or other image-based documents.

An object of the present invention is to provide a method to easily organize bookmarks in documents.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a method for displaying a document, which includes: defining a plurality of bookmarks, each bookmark containing multiple user-defined fields of data and being associated with a location within the document; displaying a content of the document in a first pane of a display window; displaying the plurality of bookmarks in a second pane of the display window; and in response to a user selecting one of the plurality of bookmarks, re-displaying the content of the document at a location associated with the selected bookmark.

The method may further include displaying each of the plurality of bookmarks using a color, the color being determined based on a data value of a specified data field of the bookmark. The method may further include displaying the plurality of bookmarks in an order according to data values of a selected data field of the plurality of bookmarks. The document may be a multipage PDF document.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates a conventional PDF display including bookmarks.

FIG. 2 schematically illustrates a bookmark containing multiple fields of data according to an embodiment of the present invention.

FIG. 3 illustrates an exemplary document display including multi-field bookmarks according to an embodiment of the present invention.

FIG. 4 illustrates another exemplary document display including multi-field bookmarks according to an embodiment of the present invention.

FIG. 5 illustrates another exemplary document display including multi-field bookmarks using color-coding according to an embodiment of the present invention.

FIG. 6 illustrates another exemplary document display including multi-field bookmarks sorted by data values of a data field according to an embodiment of the present invention.

### DETAILED DESCRIPTION OF THE PREFERRED EMBODIMENTS

Embodiments of the present invention provide an improved method for organizing bookmarks of a document. A PDF document is used as an example, but the method may be applied to other types of documents such as tiff, etc.

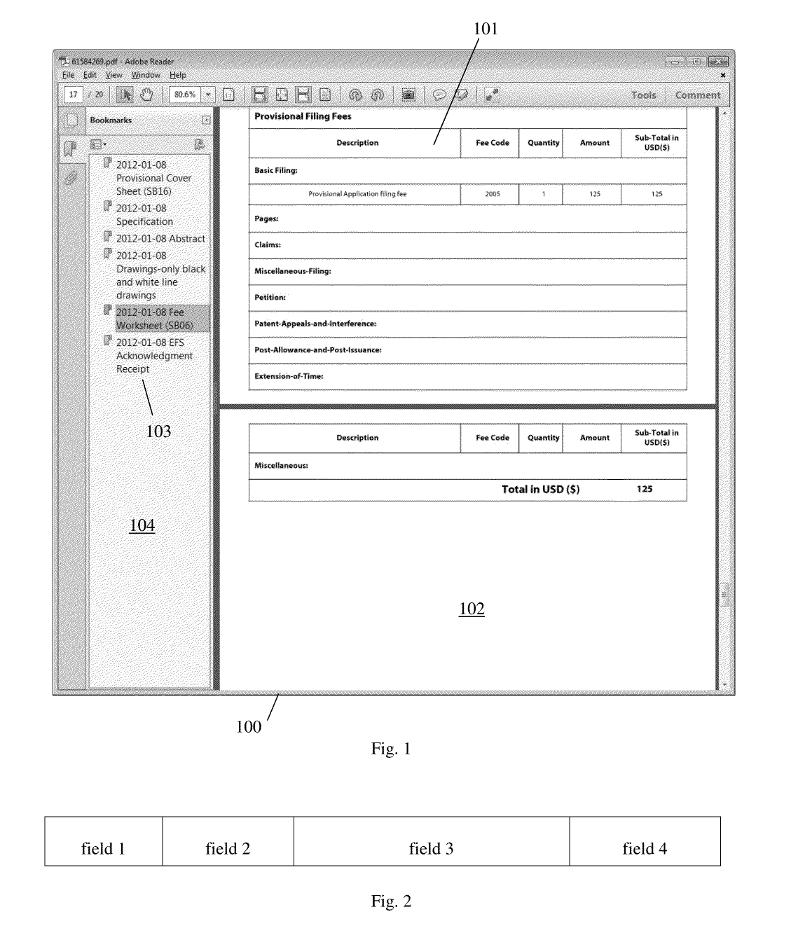

FIG. 1 shows an example of conventional bookmarks in a PDF document. Within the window 100 of the software application, the content 101 of the document is displayed in a first window pane 102 (the document pane), and a number of bookmarks 103 which has been created for the document are shown in a second window pane 104 (the bookmark pane) next to the first window pane. Each bookmark 103 is associated with a location or an object within the document. When the user clicks on a bookmark, the document content 101 at the location or the object associated with that bookmark is displayed in the first window pane 102.

In some conventional PDF programs, the user is allowed to input a name of each bookmark when creating bookmarks for PDF documents, and the bookmarks 103 in the bookmark pane 104 are displayed with their names. Some programs also allow the bookmarks 103 to be sorted alphabetically by their names, i.e., the bookmarks may be displayed in the bookmark pane 104 in an alphabetic order by their names. In addition, some programs allow the bookmarks 103 to be manually organized, e.g., the user may manually move the bookmarks 103 as displayed in the bookmark pane 104 to change their order. It should be noted that re-ordering the bookmarks 103 in the bookmark pane 104 does not change the location of the document to which the bookmarks are associated. Some conventional PDF programs also allow the user to format bookmarks names, such as changing the font or color in which the bookmark names are displayed.

Embodiments of the present invention provide improved methods for creating, manipulating, organizing and displaying bookmarks.

According to one embodiment of the present invention, bookmarks are created such that each bookmark contains multiple fields of data. FIG. 2 illustrates an exemplary data structure of bookmarks according to this embodiment. The number of fields may be set by the user; the meaning of each field is preferably not pre-defined and the user is free to define the meaning of the fields. In other words, the fields are preferably user-defined. For example, when the PDF document is a patient's medical record, the user may desire to create a bookmark for each report within the record, and the various fields may contain: (1) type of event, such as surgery/operative reports, diagnostic reports, follow up evaluations, initial/new patient evaluations, etc.; (2) date of the event; (3) name of the doctor who made the report; and (4) further information about the report, for examine, the nature of the diagnostic procedure (e.g. MRI, X-ray, etc.) for the diagnostic report, the nature of the surgery (e.g. hip replacement, etc.)

An appropriate graphical user interface (GUI) such as a dialog box may be used to facilitate the creation of bookmarks and the input of data into the various fields. In one implementation, the GUI may be pre-designed for a particular type of practical application, such as medical application, so that it prompts the user to enter particular fields of information such as those mentioned above. In an alternative implementation, a free-form input may be used such that the user enters text for multiple fields of each bookmark in one line separated by pre-defined field separators such as “;”.

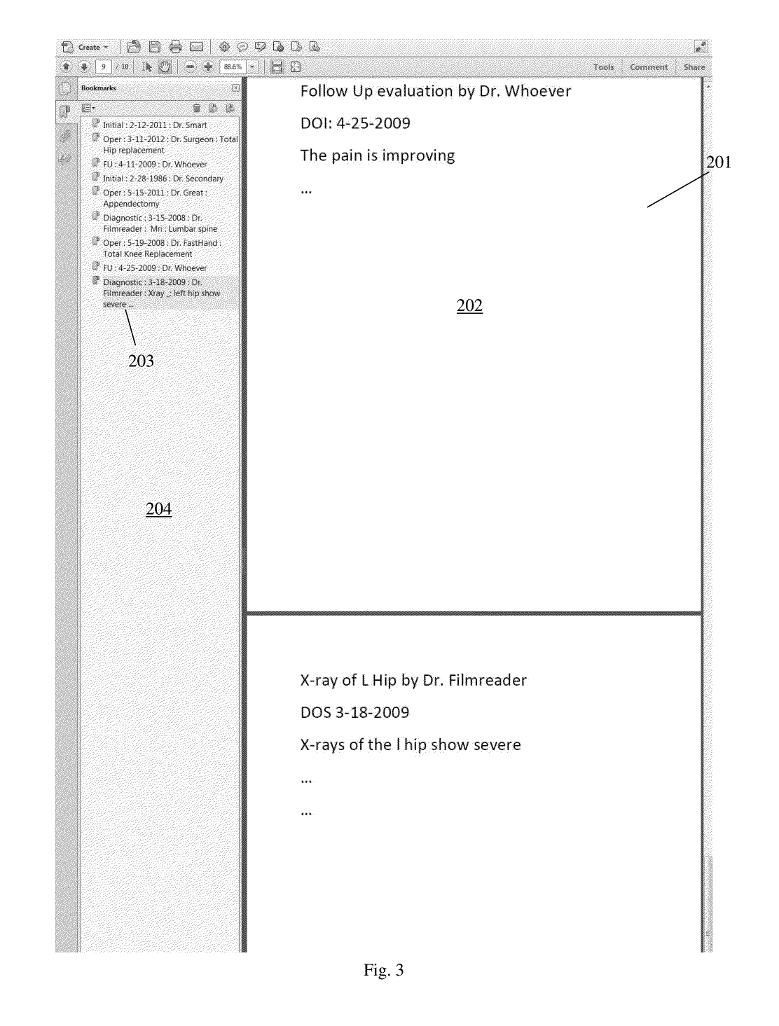

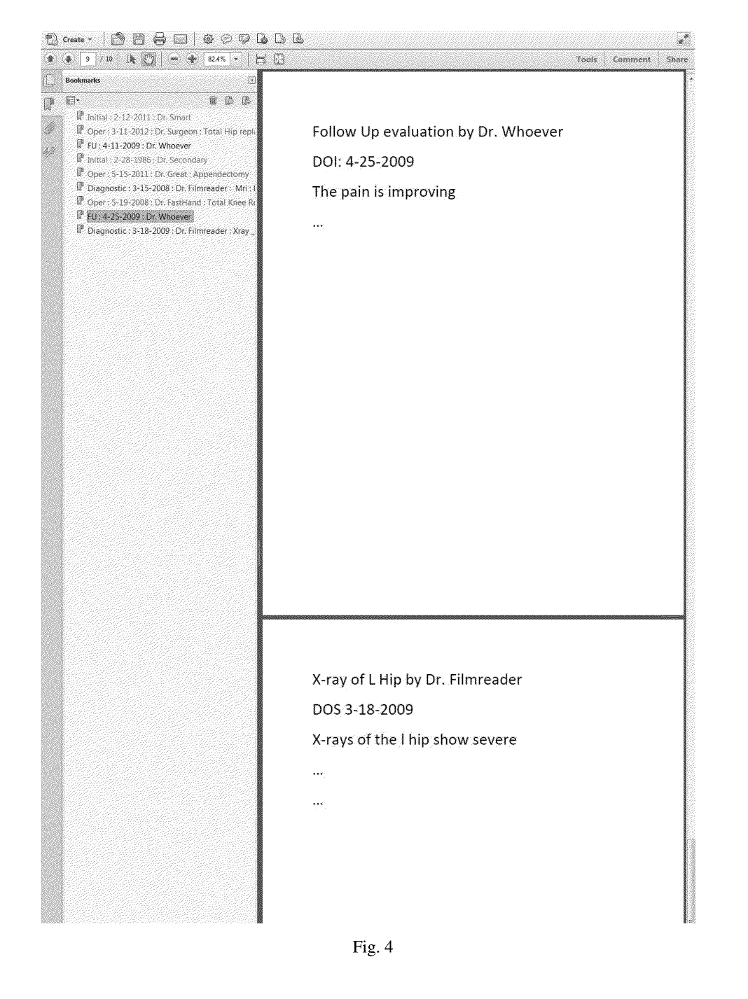

The bookmarks created according to this embodiment may be displayed in a similar manner as in conventional PDF programs. FIG. 3 illustrates an example, in which the document content 201 is displayed in a first window pane 202 (document pane), and a plurality of bookmarks 203 are displayed in a second window pane 204 (bookmark pane) next to the first pane. In this example, each bookmark is displayed with all fields in a single-line syntax with “;” as field separators. For example, the second bookmark in this example reads: “Oper ; 3-11-2012 ; Dr. Surgeon ; Total Hip Replacement”. This single-line display format is convenient as it allows the user to see all fields of the bookmarks at a glance. Other display format may be used; the invention is not limited to any particular format for displaying the bookmarks in the bookmark pane.

In addition, the bookmarks may be displayed with text wrapping (see FIG. 3) or without text wrapping (see FIG. 4). The non-wrapping display may be easier to review and is also more convenient when the patient's medical record contains numerous reports.

The information inputted for the bookmarks may be stored as metadata as a part of the PDF file, or stored in a separate file associated with the PDF file. When it is stored in a separate file, the program can associate the fields of data with the bookmarks in the PDF file. The bookmarks are preferably stored in a database structure and can be manipulated and displayed in convenient ways. Some examples are described below.

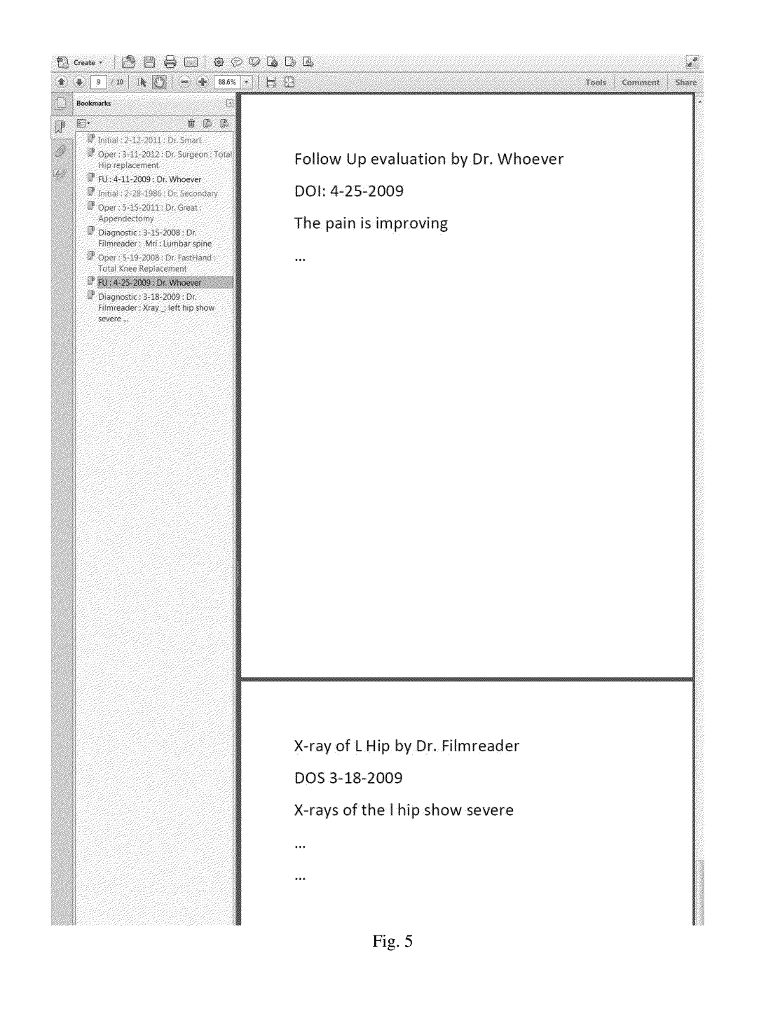

In one example, the bookmarks displayed in the bookmark pane are automatically color coded by the program. The user may pre-set the color coding based on the data in the bookmark data fields. For example, the user may pre-set the color coding based on the type of event, such that surgery/operative reports are colored red, diagnostic reports are colored blue, follow up evaluations are colored black; initial/new patient evaluations are colored green, etc. Based on the color coding setting, the display program automatically displays the bookmarks using the defined colors, either as the font color or as the highlight color. An example is shown in FIG. 5 (colors used as fond color).

Other automatic formatting, such as typeface (e.g. bold, italic, etc.) may be applied to the bookmark display. For example, all surgery events may be displayed in bold face. Again, the formatting setting may be pre-set by the user.

In another example, the display program allows for text search in the bookmark data fields.

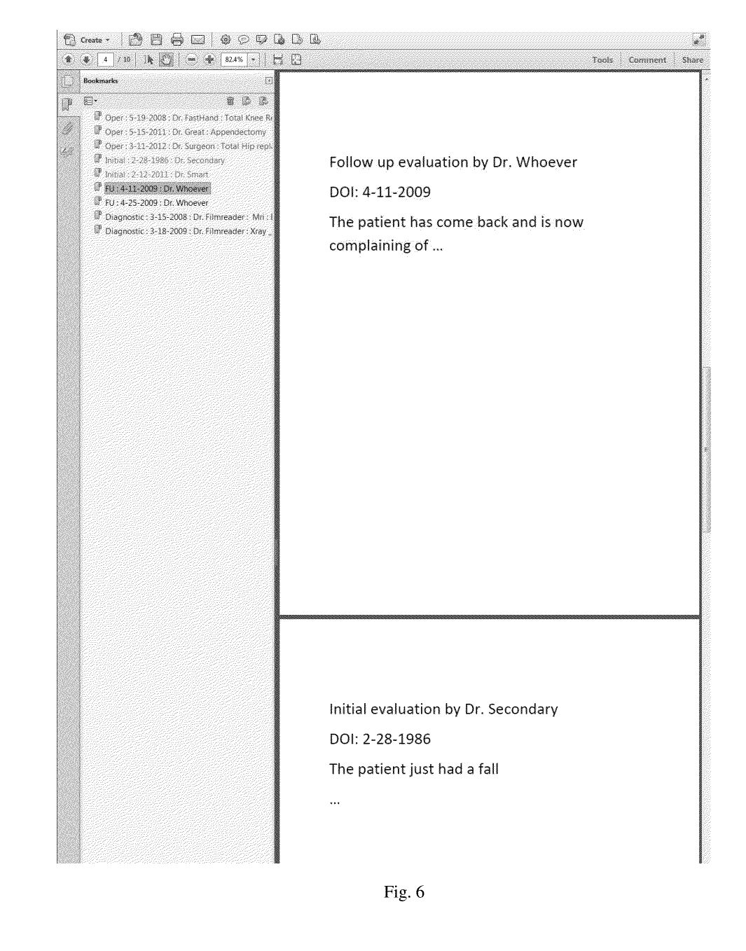

In another example, the display program sorts the bookmarks displayed in the bookmark pane by field values as specified by the user. FIG. 6 shows an example of bookmarks sorted by event type (the first field of the bookmarks). In this example, the bookmarks are also color coded by the event type, so the same colored bookmarks are displayed together. The bookmarks may also be sorted by event date, etc. The sorting may be in ascending or descending order. In addition, the bookmarks may be sorted by multiple field values. In the example shown in FIG. 6, the bookmarks are first sorted by event type (descending) and secondarily sorted by event date (ascending). It should be noted that sorting the bookmarks in the bookmark pane does not change the locations in the document to which the bookmarks are associated.

Appropriate graphical user interface tools such as icons, drop-down menus, etc. may be implemented to allow the user to specify the field(s) to perform the sort. Once the user chooses the field(s) and requests a sort, sorting is done automatically by the display program.

A display program according to an embodiment of the present invention may incorporate a combination of some or all of the features described above.

Such a program advantageously expands the functionality of bookmarks, and makes them a more useful tool for the user.

The present invention may be implemented in software programs. The program may be stored in a memory and executed by a processor of a general purpose computer.

It will be apparent to those skilled in the art that various modification and variations can be made in the bookmark creation and organization method and related apparatus of the present invention without departing from the spirit or scope of the invention. Thus, it is intended that the present invention cover modifications and variations that come within the scope of the appended claims and their equivalents.

What is claimed is:

1. A method for displaying a document, comprising:
defining a plurality of bookmarks, each bookmark containing multiple user-defined fields of data and being associated with a location or object within the document;
displaying a content of the document in a first pane of a display window;
displaying the plurality of bookmarks in a second pane of the display window; and
in response to a user selecting one of the plurality of bookmarks, re-displaying the content of the document at a location associated with the selected bookmark.

2. The method of claim 1, further comprising:
displaying each of the plurality of bookmarks using a color, the color being determined based on a data value of a specified data field of the bookmark.

3. The method of claim 1, further comprising:
displaying the plurality of bookmarks in an order according to data values of a selected data field or fields of the plurality of bookmarks.

4. The method of claim 1, wherein the document is a multipage PDF document.

5. A computer program product comprising a computer usable non-transitory medium having a computer readable program code embedded therein for controlling a data processing apparatus, the computer readable program code configured to cause the data processing apparatus to execute a process for displaying a document the process comprising:
defining a plurality of bookmarks, each bookmark containing multiple user-defined fields of data and being associated with a location or object within the document;
displaying a content of the document in a first pane of a display window;
displaying the plurality of bookmarks in a second pane of the display window; and
in response to a user selecting one of the plurality of bookmarks, re-displaying the content of the document at a location associated with the selected bookmark.

6. The computer program product of claim 5, wherein the process further comprises:
displaying each of the plurality of bookmarks using a color, the color being determined based on a data value of a specified data field of the bookmark.

7. The computer program product of claim 5, wherein the process further comprises:
displaying the plurality of bookmarks in an order according to data values of a selected data field or fields of the plurality of bookmarks.

8. The computer program product of claim 5, wherein the document is a multipage PDF document.
